(19) United States
(12) Patent Application Publication
(10) Pub. No.: US 2016/0143261 A1
(43) Pub. Date: May 26, 2016

(54) STORAGE CONTAINER AND METHOD FOR STOWING A FLEXIBLE LINE WITH AN ATTACHED DEVICE

(71) Applicant: Glen Oberacker, Jupiter, FL (US)

(72) Inventor: Glen Oberacker, Jupiter, FL (US)

(21) Appl. No.: 15/010,507

(22) Filed: Jan. 29, 2016

Related U.S. Application Data
(63) Continuation-in-part of application No. 13/627,364, filed on Sep. 26, 2012.
(60) Provisional application No. 61/539,192, filed on Sep. 26, 2011.

(51) Int. Cl. A01K 97/06; B65D 43/16; B65B 63/04

(52) U.S. Cl. CPC A01K 97/06; B65B 63/04; B65D 43/16

(57) ABSTRACT

A storage container includes a container body, a closure, a releasable securement mechanism operable to latch the container body and closure together in a closed configuration and to unlatch them from one another into an opened configuration. Also, a multiplicity of spool segments are attached on the closure and spaced apart from one another so as to define a multiplicity of slots therebetween opening into an interior storage space at an interior side of the closure surrounded by the spool segments arranged in an endless row so as to form a multi-slotted spool. The flexible line is wrapped about the multi-slotted spool and its opposite end portions are inserted through selected ones of the slots into the interior storage space for stowing on the closure and within the storage container the flexible line and at least one attached device.

### CROSS REFERENCE(S) TO RELATED APPLICATION(S)

This U.S. non-provisional patent application is a continuation-in-part application which claims the benefit of co-pending parent U.S. non-provisional patent application Ser. No. 13/627,364, filed Sep. 26, 2012, which, in turn, claims the benefit of U.S. provisional patent application No. 61/539,192, filed Sep. 26, 2011. These cited applications are incorporated-by-reference herein in their entireties.

### FIELD OF THE INVENTION

The present invention relates to equipment storage accessories, and more particularly, is concerned with a storage container and method for stowing of a flexible line with an attached device, for example a fishing rig.

### BACKGROUND OF THE INVENTION

Various types of equipment utilize flexible lines having considerable length with various devices attached to them. One example is a fishing rig with a flexible line or leader having an attached fishing hook. During periods of non-use of the fishing rig the challenge is to be able to neatly store it in order to prevent it from becoming tangled in order that it is ready for immediate use.

One approach is to use a storage box for storing hooks and lures separate from fishing lines. Examples of such a storage box are those disclosed in U.S. Pat. No. 3,648,400 to Wolfe and U.S. Pat. No. 4,073,085 to Stremechus. However, this approach involves expenditure of time assembling the components of a fishing rig before it is ready for use. Another approach to use a storage container for storing a fishing line, such as a monofilament, with an attached device. An example of such a storage container is the one disclosed in U.S. Pat. No. 4,681,220 to Beneke. However, this approach involves storing the device in the interior of the storage container while the flexible line is wound on the exterior of the storage container where it is exposed and apt to snag on other fishing equipment.

Accordingly, there remains a need in the art for an innovation that will overcome the deficiencies of these past approaches and the problems that remain unsolved.

### SUMMARY OF THE INVENTION

The present invention overcomes the deficiencies of the known art and the problems that remain unsolved by providing an innovation directed to a storage container and method for stowing a flexible line with an attached device, such as a fishing rig, so that both the fishing rig is neatly stowed in the storage container during periods of non-use but ready for use upon opening, and removal from, the storage container.

In one aspect of the present invention, a storage container for stowing a flexible line with an attached device includes:
a container body including
   a base panel bounded by a periphery, and
   a sidewall attached on the periphery of the base panel and projecting in an upstanding relationship outwardly from the base panel, the sidewall also extending about the periphery of the base panel so as to define an interior compartment open at an outer edge of the sidewall opposite from the periphery of the base panel;
a closure movable relative to the container body so as to convert between closed and opened configurations;
a releasable securement mechanism operable to secure the container body and the closure together in the closed configuration and to release the container body and the closure from one another to place in the opened configuration; and
a multiplicity of spool segments affixed on and protruding outwardly from the closure and being arranged in an endless row and spaced apart from one another to define a multiplicity of slots between the multiplicity of spool segments and thereby a multi-slotted spool, each slot having a cross-sectional width less than that of each spool segment so as to permit passage of opposite end portions of a flexible line through each slot but not passage of a device attached to at least one of the opposite end portions of the flexible line through each slot, the multiplicity of slots extending between an outwardly-facing side of the multi-slotted spool and an inwardly-facing side of the multi-slotted spool surrounding an interior storage space along an interior side of the closure,
wherein the flexible line with the attached device is stowed by the closure in the interior storage space by being wrapped about the outwardly-facing side of the multi-slotted spool and by the opposite end portions of the flexible line being inserted through selected ones of the multiplicity of slots of the multi-slotted spool and into the interior storage space so as to stow the device attached to at least one of the opposite end portions of the flexible line and also to stow the other of the opposite end portions of the flexible line within the interior storage space such that the flexible line, the opposite end portions thereof, and the at least one attached device are also all stowed in the interior compartment of the container body when the container body and closure are secured in the closed configuration.

In another aspect of the present invention, the lid panel of the closure has a planar configuration and is pivotally attached to the container body by a first living hinge being integral to both the lid panel of the closure and the outer edge of the sidewall of the container body at one side portion of the container body. The releasable securement mechanism includes a tab pivotally attached to the periphery of the base panel of the container body by a second living hinge being integral to both the tab and the base panel of the container body at another side portion of the container body opposite to the one side portion thereof. The releasable securement mechanism also includes a set of snap-fit elements formed on an edge of the tab opposite from the second living hinge and on a portion of the peripheral edge of the lid panel of the closure, the set of snap-fit elements being configured to releasably latch with one another when the container body and closure are in the closed configuration.

In another aspect of the present invention, a storage container for stowing a flexible line with a device attached thereto includes:
a container body including
   a base panel bounded by a periphery, and
   a sidewall attached on the periphery of the base panel and projecting in an upstanding relationship outwardly from the base panel, the sidewall also extending about the periphery of the base panel so as to define an interior compartment open at an outer edge of the sidewall opposite from the periphery of the base panel;
a closure including
   a lid panel having a planar configuration and being hingedly attached to the outer edge of the sidewall of the container body at one side portion of the container body and pivotally movable toward and away from the container body to convert between closed and opened configurations with the container body,
   an inner surface on the lid panel facing in a first direction toward the interior compartment of the container body when in the closed configuration,
   an outer surface on the lid panel facing in a second direction opposite to the first direction of the inner surface, and
   a peripheral edge on the lid panel extending about the inner and outer surfaces of the lid panel and being configured to overlie the outer edge of the sidewall of the container body when in the closed configuration;
a releasable securement mechanism operable to secure the container body and the closure together in the closed configuration and to release the container body and the closure from one another to place in the opened configuration; and
a multiplicity of spool segments affixed on and protruding outwardly from the lid panel of the closure, the multiplicity of spool segments arranged in an endless row having an elliptical configuration and being spaced apart from one another to define a multiplicity of slots between the multiplicity of spool segments and thereby a multi-slotted spool, each slot having a cross-sectional width less than that of each spool segment so as to permit passage of opposite end portions of a flexible line through each slot but not passage of a device attached to at least one of the opposite end portions of the flexible line through each slot, the multiplicity of slots extending between an outwardly-facing side of the multi-slotted spool and an inwardly-facing side of the multi-slotted spool surrounding an interior storage space along the inner surface on the lid panel of the closure, each of the spool segments including
   a body portion affixed at an inner end on the inner surface of the lid panel of the closure and protruding outwardly therefrom, the body portions of the spool segments defining an annular base wall of the multi-slotted spool, and
   a head portion affixed on an outer end of the body portion and extending from the body portion transversely relative to the body portion and toward the sidewall of the container body when the closure and container body are in the closed configuration, the head portions and portions of the lid panel of the closure proximate to the head portions being spaced apart and defining opposite sidewalls of the multi-slotted spool,
wherein the flexible line with the attached device is stowed by the closure in the interior storage space by being wrapped about the outwardly-facing side of the base of the multi-slotted spool and by the opposite end portions of the flexible line being inserted through selected ones of the multiplicity of slots of the multi-slotted spool and into the interior storage space so as to stow the device attached to at least one of the opposite end portions of the flexible line and also to stow the other of the opposite end portions of the flexible line within the interior storage space such that the flexible line, the opposite end portions thereof, and the at least one attached device are also all stowed in the interior compartment of the container body when the container body and closure are secured in the closed configuration.

In another aspect of the present invention, the base panel of the container body has a plurality of openings defined through the base panel permitting support of the storage container in the closed configuration vertically on an upright tubular fixture by a strap extending around the tubular fixture and through at least some of the openings in the base panel of the container body to where end portions of the strap are secured to one another.

In another aspect of the present invention, the lid panel of the closure at the peripheral edge thereof has a corner portion extending beyond the periphery of the end panel of the container body that defines a hook permitting hanging of the storage container when in the closed configuration. Also, a multiplicity of apertures defined through the lid panel of the closure are spaced apart from one another and arranged in the same endless row configuration as the multiplicity of spool segments and are adjacent to the spool segments.

In another aspect of the present invention, a method for stowing a flexible line with an attached device, the stowing method including the steps of:
obtaining a storage container in which to stow a flexible line with an attached device wherein the storage container includes a container body defining an interior compartment, a closure movable relative to the container body so as to convert between closed and opened configurations, and a multiplicity of spool segments affixed on and protruding outwardly from the closure and being arranged in an endless row and spaced apart from one another to define a multiplicity of slots between the multiplicity of spool segments and thereby a multi-slotted spool, each slot having a cross-sectional width less than that of each spool segment so as to permit passage of opposite end portions of the flexible line through each slot but not passage of the device attached to at least one of the opposite end portions of the flexible line through each slot, the multiplicity of slots extending between an outwardly-facing side of the multi-slotted spool and an inwardly-facing side of the multi-slotted spool surrounding an interior storage space along an interior side of the closure;
placing the closure in the opened configuration relative to the container body;
placing the device, being attached to one of the opposite end portions of the flexible line, into the interior storage space at the interior side of the closure;
inserting the one of the opposite end portions of the flexible line, being attached to the device, into a first selected one of the slots of the multi-slotted spool such that the attached device is stowed adjacent to the inwardly-facing side of the multi-slotted spool in the interior storage space at the interior side of the closure and remainder of the flexible line extends from the first selected one of the slots of the multi-slotted spool and is disposed proximate to the outwardly-facing side of the multi-slotted spool;
wrapping the remainder of the flexible line about the outwardly-facing side of the multi-slotted spool such that the flexible line is wrapped about the multi-slotted spool and the device is retained in the interior storage space at the interior side of the closure;
inserting the other of the opposite end portions of the flexible line through a second selected one of the slots of the multi-slotted spool such that the other of the opposite end portions of the flexible line extends from the remainder of the flexible line wound about the multi-slotted spool into the interior storage space such that the other of the opposite end portions of the flexible line is retained in the interior storage space; and
placing the closure in the closed configuration relative to the container body such that the flexible line, the opposite end portions thereof, and the at least one attached device are also now all stowed in the interior compartment of the container body.

In another aspect of the present invention, before the step of placing the closure in the opened configuration relative to the container body the stowing method includes the step of initially unlatching the closure from the container body.

In another aspect of the present invention, after the step of placing the closure in the closed configuration relative to the container body the stowing method includes the step of latching the closure to the container body.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a top front isometric view of an exemplary embodiment of a storage container for stowing a flexible line with an attached device, such as a fishing rig having a flexible line or leader with an attached fishing hook, in accordance with aspects of the present invention, the storage container being illustrated in a closed configuration;

FIG. 2 presents a top front isometric view of the storage container originally introduced in FIG. 1, being illustrated in a partial opened configuration;

FIG. 3 presents a top front isometric view of the storage container originally introduced in FIG. 1, being illustrated in a full opened configuration, showing an end portion of a flexible line and an attached fishing hook of the fishing rig prior to carrying out a method of stowing the fishing rig in the storage container in accordance with aspects of the present invention;

FIG. 4 presents a top front isometric view of the storage container originally introduced in FIG. 1, being illustrated in the same full opened configuration as in FIG. 3, now showing the end portion of the fishing rig stowed in the storage container and the remainder of the flexible line being stowed in the storage container in carrying out of the stowing method in accordance with aspects of the present invention;

FIG. 5 presents a top front isometric view of the storage container originally introduced in FIG. 1, being illustrated in the same full opened configuration as in FIGS. 3 and 4, now showing the fishing rig stowed in the storage container before closing thereof at the conclusion of carrying out the stowing method in accordance with aspects of the present invention;

FIG. 6 presents a top front isometric view of the storage container resting upon on one of its opposite sides, the storage container being illustrated in the closed configuration and hanging from a rigid rod or taut line by a hook formed at one of the corners of the storage container; and

FIG. 7 presents a top rear isometric view of the storage container being supported vertically on an upright tubular fixture by a strap passing around the tubular fixture and through openings in the storage container to where end portions of the strap are secured to one another.

Like reference numerals refer to like parts throughout the several views of the drawings.

### DETAILED DESCRIPTION

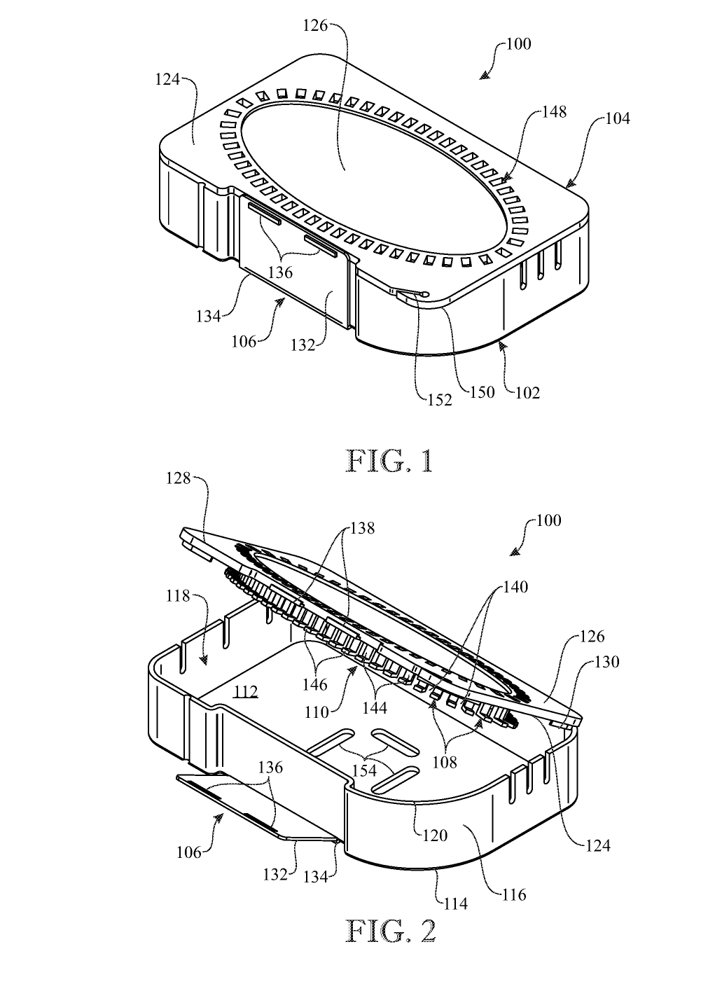

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

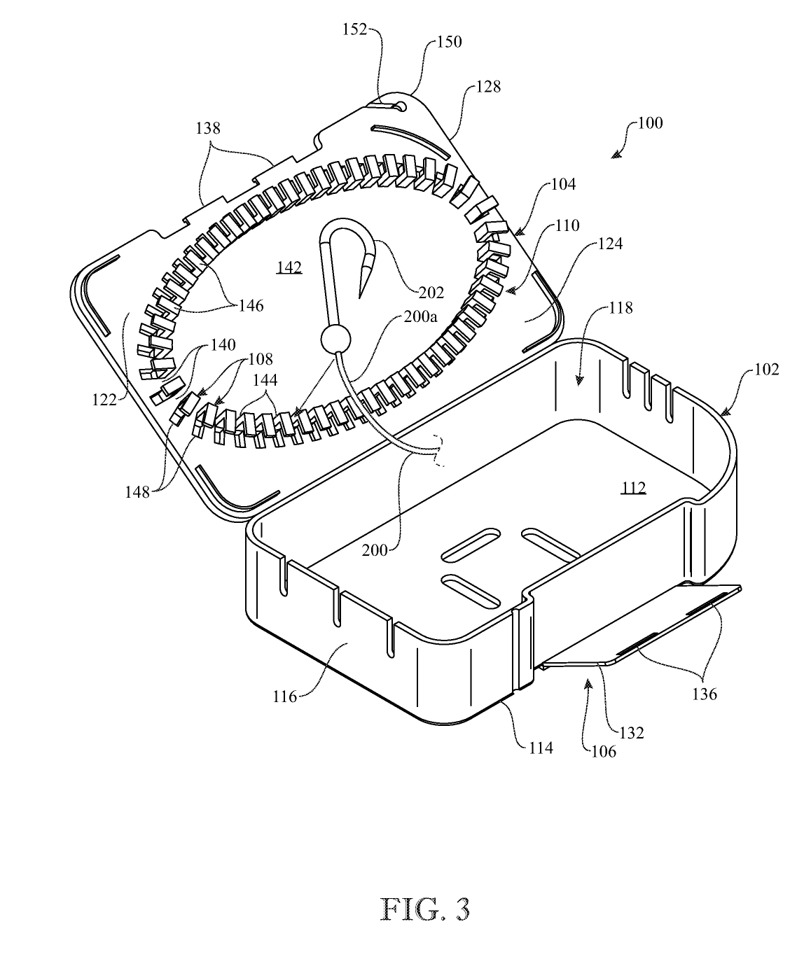

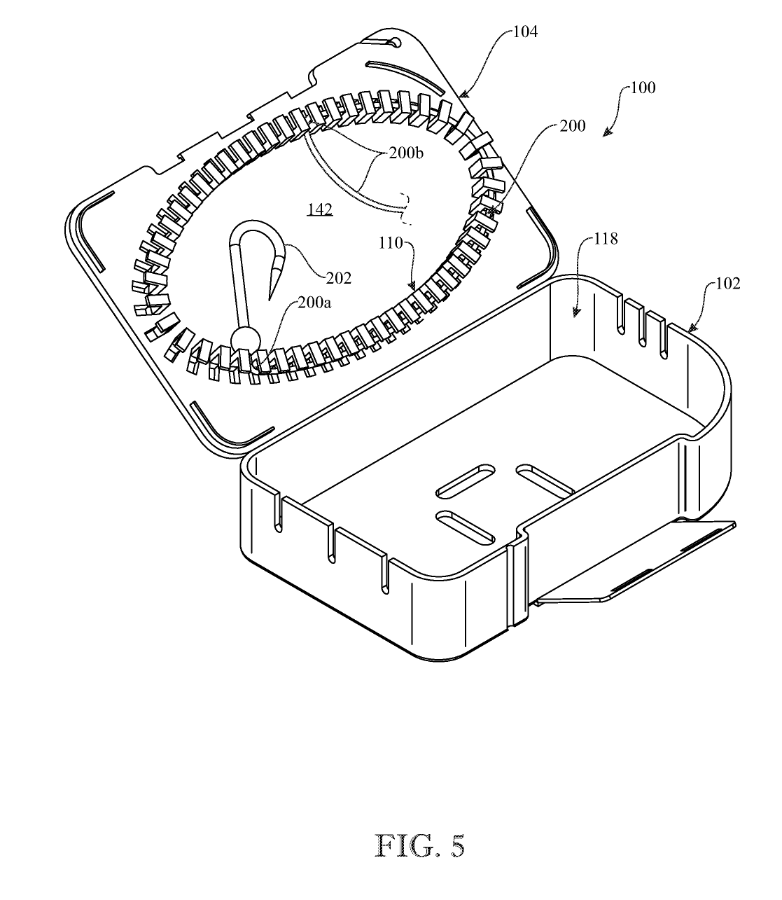

Referring now to FIGS. 1-5, there is illustrated an exemplary embodiment of a storage container, generally designated 100, in accordance with aspects of the present invention, and a method for stowing in the storage container 100, in accordance with further aspects of the present invention, a flexible line 200 with attached device(s) 202, such as a fishing rig having a flexible line or leader with an attached fishing hook, as shown in FIGS. 3-5 or alternatively a line connector. The storage container 100 is illustrated in a closed configuration in FIG. 1, a partial opened configuration in FIG. 2, and a full opened configuration in FIGS. 3-5.

The storage container 100 basically includes a container body 102, a cover or closure 104, a releasable securement mechanism 106, and a multiplicity of spool segments 108 forming a multi-slotted spool 110 attached on the inside of the closure 104. The closure 104 is movable relative to the container body 102 so as to selectively place the closure in either the closed configuration or opened configuration with the container body. The releasable securement mechanism 106 is operable to latch and hold the container body 102 and the closure 104 together to place the storage container 100 in the closed configuration. The releasable securement mechanism 106 is also operable to unlatch and release the container body 102 and the closure 104 from one another to place the storage container 100 in the opened configuration.

More particularly, the container body 102 of the storage container 100 includes a base panel 112 bounded by a periphery 114, and a sidewall 116 attached on the periphery of the base panel. The sidewall 116 is upstanding on the base panel 112, projecting outwardly therefrom, and is also substantially endless such that it extends about the periphery 114 of the base panel so as to define an interior compartment 118 open at an outer edge 120 of the sidewall opposite from the periphery of the base panel. The multi-slotted spool 110 attached on the inside of the closure 104 is covered by the container body 102 by being enclosed in the interior compartment 118 of the container body when the closure is in the closed configuration with the container body. The multi-slotted spool 110 is uncovered and thus exposed when the closure 104 is in the opened configuration with the container body 102.

The closure 102 of the storage container 100 includes a lid panel 122 having a planar configuration with opposite inner and outer surfaces 124, 126. The inner surface 124 faces in a first direction toward the interior compartment 118 of the container body 102 when the closure 104 is in the closed configuration with the container body. The outer surface 126 faces in a second direction opposite to the first direction of the inner surface 124. The lid panel 122 also has a peripheral edge 128 extending about the inner and outer surfaces 124, 126. The peripheral edge 128 of the lid panel 122 is configured to overlie the outer edge 120 of the sidewall 116 of the container body 102 when the closure 104 is in the closed configuration with the container body.

The lid panel 122 is hingedly or pivotally attached to the sidewall 116 of the container body 102 at one side portion of the container body so as to be movable toward and away from the sidewall of the container body between the closed and opened configurations with the container body. More particularly, the lid panel 122 is pivotally attached to the container body 102 by a first living hinge 130 being integral both to the outer edge 120 of the sidewall 116 of the container body at the one side portion thereof and to the lid panel 122 of the closure 104 at a portion of the peripheral edge 128 thereof adjacent to the one side portion of the container body.

The releasable securement mechanism 106 of the storage container 100 includes a tab 132 pivotally attached to the periphery 114 of the base panel 112 of the container body 102 by a second living hinge 134 being integral both to the base panel of the container body at another side portion of the container body opposite to the one side portion thereof and to the tab at a portion thereof adjacent to the another side portion of the container body. The releasable securement mechanism 106 also includes a set of snap-fit elements 136, 138 respectively formed on an edge of the tab 132 opposite from the second living hinge 134 and on an adjacent portion of the peripheral edge 128 of the lid panel 122 of the closure 104. The set of snap-fit elements 136, 138 are configured to releasably latch with one another when the container body 102 and closure 104 are in the closed configuration.

The multiplicity of spool segments 108 of the storage container 100 are affixed on and protrude outwardly from the inner surface 124 of the lid panel 122 of the closure 104. The spool segments 108 are arranged in an endless row having, by way of example but not limitation, an elliptical configuration and being spaced apart from one another to define a multiplicity of slots 140 therebetween. Each slot 140 has a cross-sectional width less than a cross-sectional width of each spool segment 108 so as to permit passage of opposite end portions 200a, 200b of the flexible line 200 through each slot 140 but not the attached device 202, which is larger in cross-section than the flexible line. The multiplicity of slots 140 extend between an outwardly-facing side of the multi-slotted spool 110 and an inwardly-facing side thereof surrounding an interior storage space 142 along the inner surface 124 of the lid panel 122 of the closure 104.

More particularly, each of the multiplicity of spool segments 108 is of an L-shaped configuration, having a body portion 144 and a head portion 146. The body portion 144 is affixed at an inner end on the lid panel 122 of the closure 104 and protruding outwardly therefrom. The body portions 114 of the spool segments 108 define an annular base wall of the multi-slotted spool 110. The head portion 146 is affixed on an outer end of the body portion 144 and extends transversely relative thereto and toward the sidewall 116 of the container body 102 when the closure 104 and the container body are in the closed configuration. The head portions 146 of the spool segments 108 and portions of the lid panel 122 of the closure 104 proximate to the head portions and being spaced apart therefrom define opposite sidewalls of the multi-slotted spool 110. Also, a multiplicity of apertures 148 are defined through the lid panel 122 of the closure 104, being spaced apart from one another and arranged in the same endless row configuration as the multiplicity of spool segments 108 and defined adjacent to the spool segments. The apertures 148 allow entry and exit of air to and from the interior compartment 118 of the container body 102 of the storage container 100 when in the closed configuration.

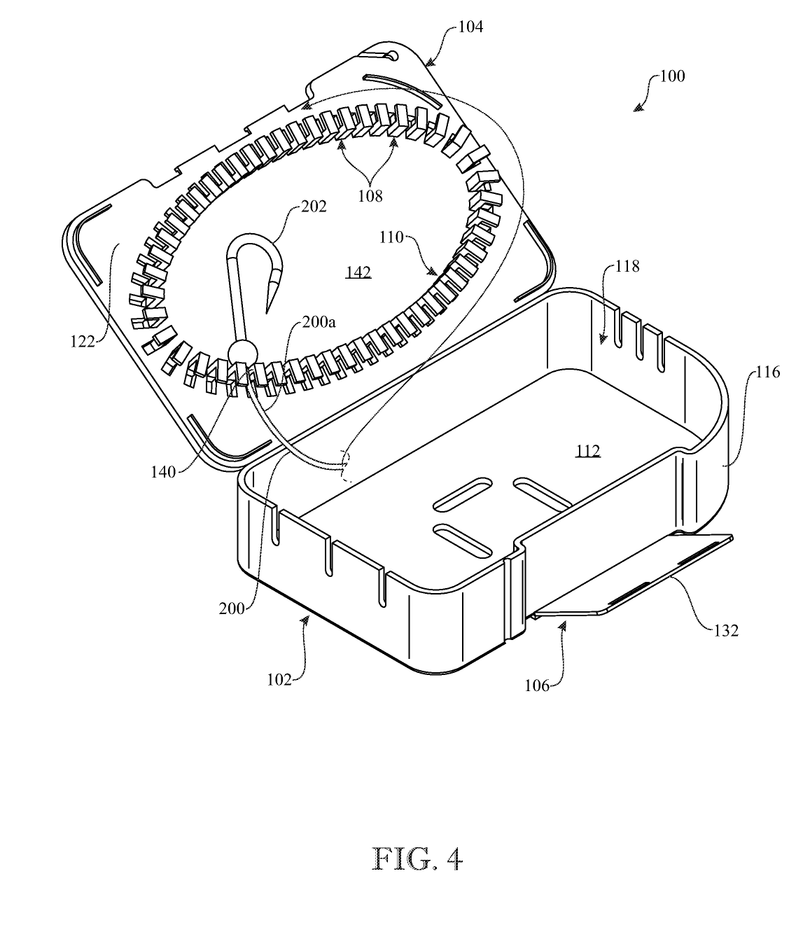

Referring now to FIGS. 3-5, there is illustrated an exemplary embodiment of a method of stowing in the storage container 100, in accordance with further aspects of the present invention, the flexible line 200 with the attached device(s) 202, such as the fishing rig having the flexible line or leader with the attached fishing hook. Initially, the storage container 100 is assumed to be in the closed configuration, as shown in FIG. 1. First, the closure 104 is unlatched from the container body 102. Second, this allows placing the closure 104 in the opened configuration relative to the container body 102, as shown in FIG. 3. Third, as also shown in FIG. 3, the device 202, being attached to the one end portion 200a of the flexible line 200, is placed into the interior storage space 142 at the interior side of the lid panel 122 of the closure 104. Fourth, as also shown in FIG. 3, the one of the opposite end portions 200a of the flexible line 200, being attached to the device 202, is inserted into a first selected one of the slots 140 of the multi-slotted spool 110 such that the attached device 202 is now stowed adjacent to the inwardly-facing side of the multi-slotted spool 110 in the interior storage space 142 at the interior side of the closure 104, as shown in FIG. 4. The remainder of the flexible line 200 now extends from the first selected one of the slots 140 of the multi-slotted spool 110 and is disposed proximate to the outwardly-facing side of the multi-slotted spool. Fifth, as shown in FIGS. 4 & 5, the remainder of the flexible line 200 is wrapped about the outwardly-facing side of the multi-slotted spool 110 such that the flexible line 200 is thereby securely wrapped about the multi-slotted spool and the device 202 is still retained in the interior storage space 142 at the interior side of the closure 104. Sixth, the other end portion 200b of the flexible line 200 is inserted through a second selected one of the slots 140 of the multi-slotted spool 110 such that the other end portion 200b of the flexible line 200 extends from the remainder of the flexible line 200, being wrapped about the outwardly-facing side of the multi-slotted spool 110, into the interior storage space 140 such that the other end portion 200b of the flexible line 200 is retained therein. Lastly, the closure 104 is placed and latched in the closed configuration relative to the container body 102 such that the flexible line 200, the opposite end portions 200a, 200b thereof, and the attached device 202 are also now all stowed in the interior compartment 118 of the container body 102 of the storage container 100 now being in the closed configuration.

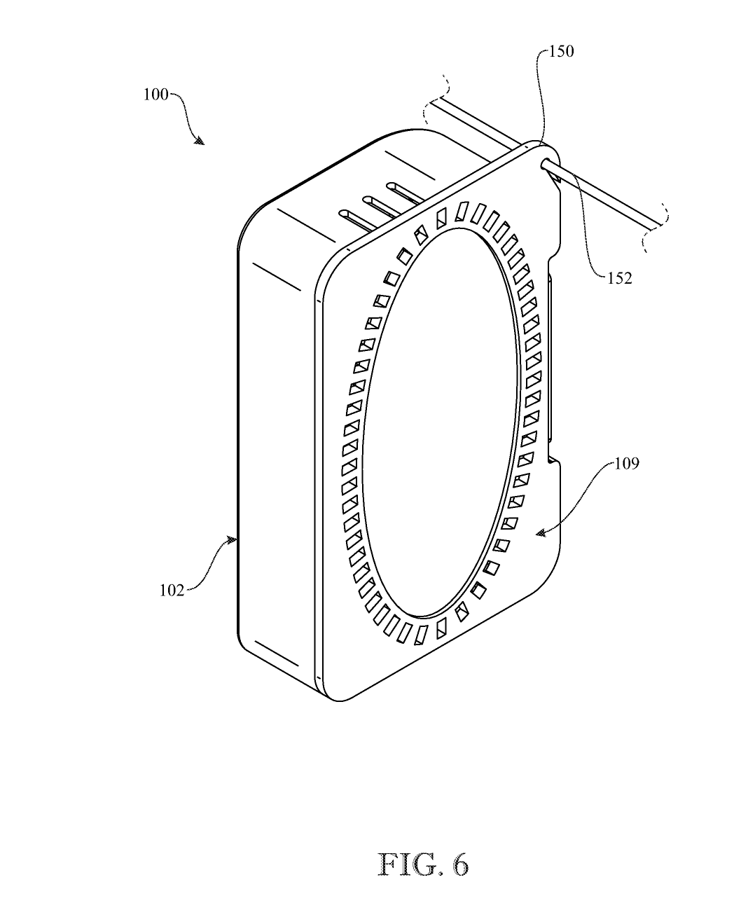

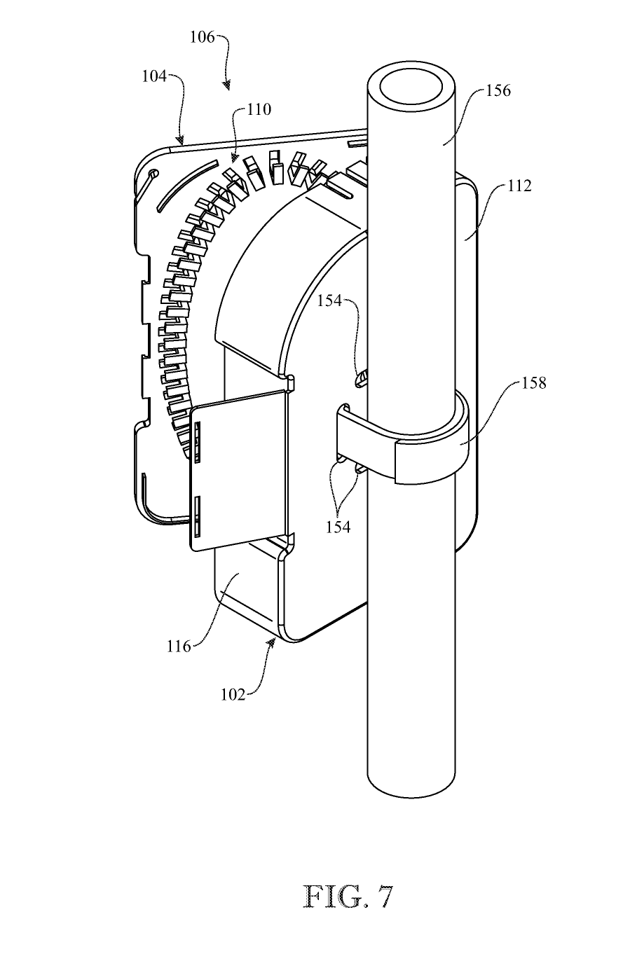

Referring to FIGS. 6 and 7, there is illustrated other aspects of the storage container 100 in accordance with the present invention. FIG. 6 shows that the lid panel of the closure at the peripheral edge thereof has a corner portion 150 extending beyond the periphery of the end panel of the container body that defines a hook 152 permitting hanging of the storage container when in the closed configuration. FIG. 7 shows that the base panel of the container body has a plurality of openings 154 defined through the base panel, permitting support of the storage container in the closed configuration vertically on an upright tubular fixture 156 by a strap 158. The strap 158 is extended around the tubular fixture 156 and through at least some of the openings 154 in the base panel of the container body to where end portions of the strap are secured to one another

Other examples of flexible lines and devices that may employ the storage container 100 might be power lines for electrical equipment (computers, mobile phones and music and video devices) having component connections and playback earphones attached thereto. The storage container 100 as a unitary product or its container body 102 and closure 104 (with the multi-stored spool 110 thereon) as separate components may be fabricated from a suitable plastic using conventional molding techniques.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A storage container for stowing a flexible line with an attached device, said storage container comprising:
a container body comprising
a base panel bounded by a periphery, and
a sidewall attached on said periphery of said base panel and projecting in an upstanding relationship outwardly from said base panel, said sidewall also extending about said periphery of said base panel so as to define an interior compartment open at an outer edge of said sidewall opposite from said periphery of said base panel;
a closure movable relative to said container body so as to convert between closed and opened configurations;
a releasable securement mechanism operable to secure said container body and said closure together in said closed configuration and to release said container body and said closure from one another to place in said opened configuration; and
a multiplicity spool segments affixed on and protruding outwardly from said closure and being arranged in an endless row and spaced apart from one another to define a multiplicity of slots between said multiplicity of spool segments and thereby a multi-slotted spool, each slot having a cross-sectional width less than that of each spool segment so as to permit passage of opposite end portions of a flexible line through each slot but not passage of a device attached to at least one of the opposite end portions of the flexible line through each slot, said multiplicity of slots extending between an outwardly-facing side of said multi-slotted spool and an inwardly-facing side of said multi-slotted spool surrounding an interior storage space along an interior side of said closure;
wherein the flexible line with the attached device is stowed by said closure in said interior storage space by being wrapped about said outwardly-facing side of said multi-slotted spool and by the opposite end portions of the flexible line being inserted through selected ones of said multiplicity of slots of said multi-slotted spool and into said interior storage space so as to stow the device attached to at least one of the opposite end portions of the flexible line and also to stow the other of the opposite end portions of the flexible line within said interior storage space such that the flexible line, the opposite end portions thereof, and the at least one attached device are also all stowed in said interior compartment of said container body when said container body and closure are secured in said closed configuration.

2. The storage container of claim 1 wherein said closure comprises a lid panel having a planar configuration and being movable toward and away from said sidewall of said container body between said closed and opened configurations with said container body.

3. The storage container of claim 2 wherein said lid panel of said closure comprises:
an inner surface facing in a first direction toward said interior compartment of said container body when in said closed configuration;
an outer surface facing in a second direction opposite to said first direction of said inner surface; and
a peripheral edge extending about said inner and outer surfaces and being configured to overlie said peripheral edge of said container body when said storage container is in said closed configuration.

4. The storage container of claim 3 wherein:
said lid panel of said closure is hingedly attached to said sidewall of said container body at one side portion of said container body; and
said releasable securement mechanism comprises
a tab hingedly attached to said periphery of said base panel of said container body at another side portion of said container body opposite said one portion, and
a set of snap-fit elements formed on said tab and on a portion of said peripheral edge of said lid panel, said set of snap-fit elements being configured to releasably latch with one another when said closure and said container body are in said closed configuration.

5. The storage container of claim 4 wherein said lid panel of said closure is pivotally attached to said container body by a first living hinge being integral to both said lid panel of said closure and said outer edge of said sidewall of said container body at said one side portion of said container body.

6. The storage container of claim 5 wherein said tab is pivotally attached to said periphery of said base panel of said container body by a second living hinge being integral to both said tab and said base panel of said container body at said another side portion of said container body opposite to said one side portion thereof.

7. The storage container of claim 1 wherein each of said multiplicity of spool segments comprises:
a body portion affixed at an inner end on said closure and protruding outwardly therefrom, said body portions of said spool segments defining an annular base wall of said multi-slotted spool; and
a head portion affixed on an outer end of said body portion and extending from said body portion toward said sidewall of said container body when said closure and container body are in said closed configuration, said head portions and portions of said closure proximate to said head portions being spaced apart and defining opposite sidewalls of said multi-slotted spool.

8. The storage container of claim 7 wherein said head portion extends from said body portion toward said sidewall of said container body and transversely relative to said body portion when said container body and said closure are in said closed configuration such that together said body and head portions of each of said multiplicity of spool segments has an L-shaped configuration with respect to said closure.

9. The storage container of claim 1 further comprising a multiplicity of apertures defined through said closure, said apertures spaced apart from one another and arranged in the same endless row configuration as said spool segments and being adjacent to said spool segments.

10. A storage container for stowing a flexible line with an attached device, said storage container comprising:
a container body comprising
a base panel bounded by a periphery, and
a sidewall attached on said periphery of said base panel and projecting in an upstanding relationship outwardly from said base panel, said sidewall also extending about said periphery of said base panel so as to define an interior compartment open at an outer edge of said sidewall opposite from said peripheral of said base panel;
a closure comprising
a lid panel having a planar configuration and being hingedly attached to said outer edge of said sidewall of said container body at one side portion of said container body and being pivotally movable toward and away from said container body to convert between closed and opened configurations with said container body,
an inner surface on said lid panel facing in a first direction toward said interior compartment of said container body when in said closed configuration,
an outer surface one said lid panel facing in a second direction opposite to said first direction of said inner surface, and
a peripheral edge on said lid panel extending about said inner and outer surfaces of said lid panel and being configured to overlie said outer edge of said sidewall of said container body when in said closed configuration;
a releasable securement mechanism operable to secure said container body and said closure together in said closed configuration and to release said container body and said closure from one another to place in said opened configuration; and
a multiplicity of spool segments affixed on and protruding outwardly from said lid panel of said closure, said multiplicity of spool segments arranged in an endless row having an elliptical configuration and being spaced apart from one another to define a multiplicity of slots between said multiplicity of spool segments and thereby a multi-slotted spool, each slot having a cross-sectional width less than that of each spool segment so as to permit passage of opposite end portions of a flexible line through each said slot but not passage of a device attached to at least one of the opposite end portions of the flexible line through each said slot, said multiplicity of slots extending between an outwardly-facing side of said multi-slotted spool and an inwardly-facing side of said multi-slotted spool surrounding an interior storage space along said inner surface of said lid panel of said closure, each of said spool segments comprising
a body portion affixed at an inner end on said inner surface of said lid panel of said closure and protruding outwardly therefrom, said body portions of said spool segments defining an annular base of said multi-slotted spool, and
a head portion affixed on an outer end of said body portion and extending from said body portion transversely relative to said body portion and toward said sidewall of said container when said closure and container body are in said closed configuration, said head portions and portions of said lid panel of said closure proximate to said head portions being spaced apart and defining opposite sidewalls of said multi-slotted spool,
wherein the flexible line with the attached device are stowed by said closure in said interior storage space by being wrapped about said outwardly-facing side of said base of said multi-slotted spool and by the opposite end portions of the flexible line being inserted through selected ones of said multiplicity of slots of said multi-slotted spool and into said interior storage space so as to stow the device attached to at least one of the opposite end portions of the flexible line and also to stow the other of the opposite end portions of the flexible line within said interior storage space such that the flexible line, the opposite end portions thereof, and the at least one attached device are also all stowed in said interior compartment of said container body when said container body and closure are secured in said closed configuration.

11. The storage container of claim 10 wherein said releasable securement mechanism comprises:
a tab hingedly attached to said periphery of said end panel of said container body at another side portion of said container body opposite said one side portion; and
a set of snap-fit elements formed on said tab and on a portion of said peripheral edge of said lid panel, said set of snap-fit elements being configured to releasably latch with one another when is in said closed configuration.

12. The storage container of claim 11 wherein said lid panel of said closure is pivotally attached to said container body by a first living hinge being integral to both said lid panel of said closure and said outer edge of said sidewall of said container body at said one side portion of said container body.

13. The storage container of claim 12 wherein said tab is pivotally attached to said periphery of said end panel of said container body by a second living hinge being integral to both said tab and said end panel of said container body at said another side portion of said container body opposite to said one side portion thereof.

14. The storage container of claim 10 wherein said head portion extends from said body portion toward said sidewall of said container body and transversely relative to said body portion when said container body and said closure are in said closed configuration such that together said body and head portions of each of said multiplicity of spool segments has an L-shaped configuration with respect to said lid pane of said closure.

15. The storage container of claim 10 wherein said base panel of said container body has a plurality of openings defined through said base panel permitting support of said storage container in said closed configuration vertically on an upright tubular fixture by a strap extending around the tubular fixture and through at least some of said openings in said base panel of said container body to where end portions of said strap are secured to one another.

16. The storage container of claim 10 wherein said lid panel of said closure at said peripheral edge thereof has a corner portion extending beyond said periphery of said end panel of said container body that defines a hook permitting hanging of said storage container when in said closed configuration.

17. The storage container of claim 10 wherein further comprising a multiplicity of apertures defined through said lid panel of said closure, said apertures spaced apart from one another and arranged in the same endless row configuration as said spool segments and being adjacent to said spool segments.

18. A method for stowing a flexible line with an attached device in a storage container, said stowing method comprising the steps of:
obtaining a storage container in which to stow a flexible line with an attached device wherein the storage container includes a container body defining an interior compartment, a closure movable relative to the container body so as to convert between closed and opened configurations, and a multiplicity of spool segments affixed on and protruding outwardly from the closure and being arranged in an endless row and spaced apart from one another to define a multiplicity of slots between the multiplicity of spool segments and thereby a multi-slotted spool, each slot having a cross-sectional width less than that of each spool segment so as to permit passage of opposite end portions of the flexible line through each slot but not passage of the device attached to at least one of the opposite end portions of the flexible line through each slot, the multiplicity of slots extending between an outwardly-facing side of the multi-slotted spool and an inwardly-facing side of the multi-slotted spool surrounding an interior storage space along an interior side of the closure;
placing the closure in the opened configuration relative to the container body;
placing the device, being attached to one of the opposite end portions of the flexible line, into the interior storage space at the interior side of the closure; inserting the one of the opposite end portions of the flexible line, being attached to the device, into a first selected one of the slots of the multi-slotted spool such that the attached device is stowed adjacent to the inwardly-facing side of the multi-slotted spool in the interior storage space at the interior side of the closure and remainder of the flexible line extends from the first selected one of the slots of the multi-slotted spool and is disposed proximate to the outwardly-facing side of the multi-slotted spool;
wrapping the remainder of the flexible line about the outwardly-facing side of the multi-slotted spool such that the flexible line is wrapped about the multi-slotted spool and the device is retained in the interior storage space at the interior side of the closure;
inserting the other of the opposite end portions of the flexible line through a second selected one of the slots of the multi-slotted spool such that the other of the opposite end portions of the flexible line extends from the remainder of the flexible line wrapped about the multi-slotted spool into the interior storage space such that the other of the opposite end portions of the flexible line is retained in the interior storage space; and
placing the closure in the closed configuration relative to the container body such that the flexible line, the opposite end portions thereof, and the at least one attached device are also now all stowed in the interior compartment of the container body.

19. The stowing method of claim 18 further comprising, before the step of placing the closure in the opened configuration relative to the container body, the step of initially unlatching the closure from the container body, as an initial step, unlatching the closure from the container body.

20. The stowing method of claim 18 further comprising, after the step of placing the closure in the closed configuration relative to the container body, the step of latching the closure to the container body.
